(19) United States
(12) Patent Application Publication
(10) Pub. No.: US 2018/0019857 A1
(43) Pub. Date: Jan. 18, 2018

(54) CONTROLLING SIMULTANEOUS TRANSMISSION/RECEPTION OF A RADIO NODE IN A SYSTEM WITH TDD CELLS

(71) Applicant: Telefonaktiebolaget LM Ericsson (publ), Stockholm (SE)

(72) Inventors: Muhammad KAZMI, Sundbyberg (SE); Iana SIOMINA, Täby (US)

(21) Appl. No.: 15/547,711

(22) PCT Filed: Feb. 10, 2016
(86) PCT No.: PCT/SE2016/050100

§ 371 Date: Jul. 31, 2017

Related U.S. Application Data
(60) Provisional application No. 62/114,265, filed on Feb. 10, 2015.

(51) Int. Cl. H04L 5/14; H04J 3/14; H04W 72/04; H04W 72/08

(52) U.S. Cl. CPC H04L 5/14; H04W 72/082; H04J 3/14; H04W 72/048

(57) ABSTRACT

The present disclosure pertains to a method and device for operating a user equipment for a wireless communication network. The user equipment is configured for carrier aggregation and the method includes operating based on a measurement configuration. The operating includes operating with one direction of transmission during measurement or positioning subframes configured by the configuration.

### TECHNICAL FIELD

The present disclosure pertains to wireless communication technology, in particular related to measurements performed by a terminal like a UE.

### BACKGROUND

Devices for modern wireless communication technology are becoming more and more powerful and flexible. For example, many device can support carrier aggregation and/or simultaneous transmission and reception on a carrier (duplex operation). However, with the introduction of such advanced functionality, and the fact that not all device support all possible functionalities (e.g., due to cost restrictions in manufacturing), a large variety of possible operational behaviour arises, which can lead to undesired interference and downgrade operational efficiency.

### SUMMARY

It is an object of the present disclosure to described approaches facilitating efficient measurements in a wireless communication network, in particular for carrier aggregation scenarios and/or in regards whether a user equipment is adapted for advanced functionality like duplex operation.

There is described a method for operating a user equipment for a wireless communication network, wherein the user equipment is configured for carrier aggregation. The method comprises operating based on a measurement configuration, wherein operating comprises operating with one direction of transmission during measurement or positioning subframes configured by the configuration.

Moreover, there is described a user equipment for a wireless communication network. The user equipment is configured for carrier aggregation. Furthermore, the user equipment is adapted for operating based on a measurement configuration, wherein operating comprises operating with one direction of transmission during measurement or positioning subframes configured by the configuration.

A method for operating a network node for a wireless communication network is also disclosed. The method comprises configuring a user equipment configured for carrier aggregation with a measurement configuration for operating with one direction of transmission during measurement or positioning subframes configured by the configuration.

In addition, there is suggested a network node for a wireless communication network, the network node being adapted for configuring a user equipment configured for carrier aggregation with a measurement configuration for operating with one direction of transmission during measurement or positioning subframes configured by the configuration.

There is also disclosed a program product comprising code executable by control circuitry, the code causing the control circuitry to carry out and/or control any of the methods described herein.

Also described is a carrier medium arrangement carrying and/or storing a program product as described herein and/or code executable by control circuitry, the code causing the control circuitry to perform and/or control any of the methods described herein.

The user equipment generally may be adapted for and/or capable of carrier aggregation. It may be considered that the network node configures, and/or is adapted for configuring and/or comprises a configuring module for configuring, the user equipment for carrier aggregation.

The measurement configuration may pertain to one or more carriers and/or cells of the carrier aggregate, in particular it may indicate one or more carriers or cells on which the user equipment is to perform measurement/s on, and/or indicate parameters pertaining to the measurement/s, e.g. frequency of measurement/s and/or on what signal or signal pattern to measure on and/or what to measure, and/or indicate parameters pertaining to reporting measurement results. The measurement configuration may directly or indirectly indicate the one direction for operation.

Generally, a user equipment configured for carrier aggregation may be set up (configured) for operating on a carrier aggregate. The one direction of transmission may be uplink or downlink. Operating with one direction of transmission during measurement or positioning subframes may pertain to one or more carriers and/or cells of the carrier aggregate. Alternatively or additionally, operating with one direction of transmission during measurement or positioning subframes may be considered to exclude operating in the other direction during these subframes, in particular regarding the cells and/or carriers of the carrier aggregate. Configuring for carrier aggregation may be separate from configuring with a measurement configuration. Alternatively, configuring with a measurement configuration may comprise (e.g., simultaneously) configuring for carrier aggregation, and/or a measurement configuration may comprise a carrier aggregation configuration, or vice versa. Such a configuration may e.g. be represented by one single or separate configuration message used for configuring.

The approaches described herein facilitate measurements in carrier aggregation scenarios being performed efficiently and with limited interference. As the overall network operation depends on the quality of the measurements, this allows more efficient network operation.

### BRIEF DESCRIPTION OF THE DRAWINGS

The drawings are provided to illustrate concepts and approaches of the disclosure and are not intended as limitation. The drawings comprise:

FIG. 1, showing a LTE frame structure of type 1;

FIG. 2, showing a LTE frame structure of type 2;

FIG. 3, showing an exemplary user equipment;

FIG. 4, showing an exemplary network node;

FIG. 5, showing a flowchart of a method for operating a user equipment;

FIG. 6, showing another exemplary user equipment;

FIG. 7, showing a flowchart of a method for operating a network node; and

FIG. 8, showing an exemplary network node.

### DETAILED DESCRIPTION

A UE, which might not support simultaneous reception and transmission on different cells, may be scheduled data on any UL or DL subframe. If the UE is performing measurements on subframes whose direction is opposite to that of the subframes where it is being scheduled at the same time in another cell, severe performance degradation of the measurement may occur, or in the worst case the measurement may be missed. This in turn will adversely affect procedures like mobility, positioning, RRM in general, etc., which depend on UE measurements. Even network measurements may be affected when e.g. the measurement is bidirectional such as eNodeB RxTx. Instead of or in addition to degrading measurement performance, the UE may also start dropping transmissions (e.g. in UL or DL) and will thus degrade the service performance; furthermore, the network may be not aware of this UE behaviour and may believe that the UE utilizes all the resources scheduled by the network, which also results in inefficient network resource utilization.

There are described concepts and approaches to facilitate that the measurements are done and meet the requirements.

The approaches described herein apply to all the radio measurement types (including UE measurements and radio network node measurements) indicated herein, in particular below, but are not limited to them.

UE measurements are described in the following.

Radio measurements done by the UE are typically performed on the serving as well as on neighbor cells over some known reference symbols or pilot sequences. A UE may be adapted to carry out any one or any combination of such measurements and/or comprise a measurement module for carrying such measurement/s. It may be considered that the UE carries out, and/or that the UE or the measurement module is adapted for carrying out, any such measurement/s based on a configuration.

The UE may be configured by the network and/or a network node (which may be referred to as a radio network node). The measurements may be done on cells and/or carriers on an intra-frequency carrier, inter-frequency carrier(s) as well as on inter-RAT carriers(s) (depending upon the UE capability to support such a RAT). To enable inter-frequency and inter-RAT measurements for the UE requiring gaps, the network (in particular, the network node) may configure the measurement gaps and/or be adapted for such configuring and/or comprise a corresponding configuring module.

Two periodic measurement gap patterns both with a measurement gap length of 6 ms are defined for LTE. Some measurements may also require the UE to measure the signals transmitted by the UE in the uplink.

The measurements may be done for various purposes. Some example measurement purposes are: mobility, positioning, self-organizing network (SON), minimization of drive tests (MDT), operation and maintenance (O&M), network planning and optimization etc.

The measurements are typically performed over a measurement time duration or interval, in particular a relatively longer time duration (e.g., longer than a slot or subframe or even frame), e.g. in the order of few 100 ms up to several seconds. Similar measurements are applicable in single carrier and CA.

However, in carrier aggregation the measurement requirements may be different. For example, the measurement period may be different in CA, e.g. it can be either relaxed or more stringent depending upon whether the SCC (Secondary Component Carrier) is activated or not. This may also depend upon the UE capability i.e. whether a CA capable UE is able to perform measurement on SCC with or without gaps.

Examples of mobility measurements in LTE are:

Cell identification aka PCI acquisition

Reference symbol received power (RSRP)

Reference symbol received quality (RSRQ)

CGI acquisition

The mobility measurement may also comprise of identifying or detecting a cell, which may belong to LTE, HSPA, CDMA2000, GSM, etc. The cell detection comprises identifying at least the physical cell identity (PCI) and subsequently performing the signal measurement (e.g. RSRP) of the identified cell. The UE may also have to acquire the cell global ID (CGI) of a UE. More specifically the SI is read by the UE to acquire the cell global identifier (CGI), which uniquely identifies a cell, of the target cell. The UE also be requested to acquire other information such as CSG indicator, CSG proximity detection etc from the target cell.

Examples of UE positioning measurements in LTE are:

Timing measurements such as reference signal time difference (RSTD), UE RX-TX time difference measurement, eNodeB RX-TX time difference measurement

power-based measurements (e.g. RSRP or RSRQ) performed for positioning purpose

The UE RX-TX time difference measurement may comprise the UE performing measurement on the downlink reference signal as well as on the uplink transmitted signals.

Example of other measurements which may be used for radio link maintenance, MDT, SON or for other purposes are:

Control channel failure rate or quality estimate e.g.

Paging channel failure rate

Broadcast channel failure rate

Physical layer problem detection e.g.

Out of synchronization (out of sync) detection.

In synchronization (in-sync) detection.

Radio link monitoring

Radio link failure determination or monitoring

CSI measurements performed by the UE are used for scheduling, link adaptation etc. by network. Examples of CSI measurements are CQI, PMI, RI etc. They may be performed on reference signals like CRS, CSI-RS or DMRS.

The radio measurements performed by the UE may be used by the UE for one or more radio operational tasks. Examples of such tasks are reporting the measurements to the network (e.g. a network node, in particular a network node configuring and/or serving the UE), which in turn may use them for various tasks. For example, in RRC connected state, the UE may report radio measurements to the serving node. In response to the reported UE measurements, the serving network node may take certain decisions e.g. it may send mobility command to the UE for the purpose of cell change. Examples of cell change are handover, RRC connection re-establishment, RRC connection release with redirection, PCell change in CA, PCC change in PCC etc. In idle or low activity state example of cell change is cell reselection. In another example the UE may itself use the radio measurements for performing tasks e.g. cell selection, cell reselection, etc.

Radio network node radio measurements are discussed in the following.

In order to support different functions such as mobility (e.g. cell selection, handover, etc.), positioning a UE, link adaption, scheduling, load balancing, admission control, interference management, interference mitigation etc, the radio network node may perform, and/or be adapted to and/or comprise a measuring module adapted to perform, radio measurement/s on signals transmitted and/or received by the radio network node, which may e.g. be transmitted by and/or received from one or more UEs. Examples of such measurements are SNR, SINR, received interference power (RIP), BLER, propagation delay between UE and itself, transmit carrier power, transmit power of specific signals (e.g. Tx power of reference signals), positioning measurements, etc.

Duplex configurations are discussed in the following.

A duplex communication system is a point-to-point system composed of two connected parties or devices that can communicate with one another in both directions.

A half-duplex (HDX) system provides communication in both directions, but only one direction at a time (not simultaneously).

A full-duplex (FDX), or sometimes double-duplex system, allows communication in both directions, and, unlike half-duplex, allows this to happen simultaneously. Half-duplex and/or full-duplex may in particular pertain to a specific transmission path or medium, e.g. utilizing a carrier or frequency band—a carrier or band may be used for full-duplex if it is simultaneously used for transmissions in both direction (or simultaneous transmission and reception as seen from one device/party).

Time-division duplexing (TDD) is the application of time-division multiplexing to separate outward and return signals, i.e. operating over a half-duplex communication link.

Frequency-division duplexing (FDD) means that the transmitter and receiver operate at different carrier frequencies, typically separated by a frequency offset.

LTE specification enables FDD and TDD operation modes. Additionally, half duplex operation is also specified, which is essentially FDD operation mode but with transmission and receptions not occurring simultaneously as in TDD.

Half duplex mode has advantages with some frequency arrangements where the duplex filter may be unpractical or unreasonable, e.g. resulting in high cost and/or high power consumption. Since a number identifying a carrier like a carrier frequency number (EARFCN) is unique, by knowing it, it is possible to determine the frequency band, which is either FDD or TDD.

However, it may be more difficult to find difference between full duplex FDD and half-duplex FDD (HD-FDD) without explicit information since same FDD band can be used as full FDD or HD-FDD.

In 3GPP LTE, two radio frame structure types are currently supported: Type 1 (applicable to FDD) and Type 2 (applicable to TDD).

Transmissions in multiple cells can be aggregated where up to four secondary cells can be used in addition to the primary cell (according to the current standard; the total number of carriers/cells in a carrier aggregation may vary depending on the RAT/standard used). In case of multi-cell aggregation, the UE currently may assume the same frame structure is used in all the serving (primary and secondary) cells.

FDD is discussed in the following.

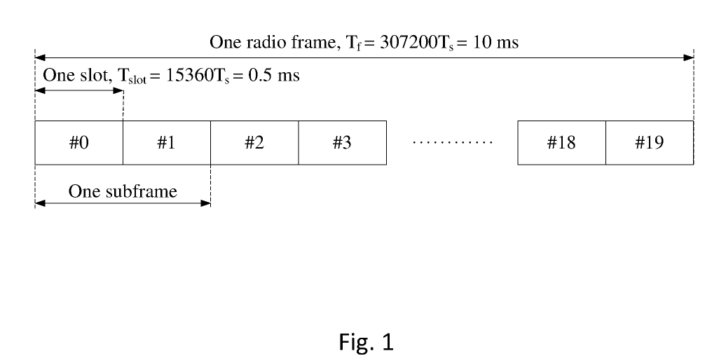

Frame structure type 1 is applicable to both full duplex and half duplex FDD, and it is as illustrated in FIG. 1.

For FDD, 10 subframes are available for downlink transmission and 10 subframes are available for uplink transmissions in each 10 ms interval (called radio frame or frame). Uplink and downlink transmissions are separated in the frequency domain. In half-duplex FDD operation, the UE cannot transmit and receive at the same time while there are no such restrictions in full-duplex FDD.

There is no need in a guard period for full-duplex FDD. For half-duplex FDD operation, a guard period may be created by the UE by not receiving the last part of a downlink subframe immediately preceding an uplink subframe from the same UE. A guard period may generally be a period in which antenna/radio circuitry is not used for transmission and/or reception, in particular when (and between) switching between transmitting and receiving.

TDD is discussed in the following.

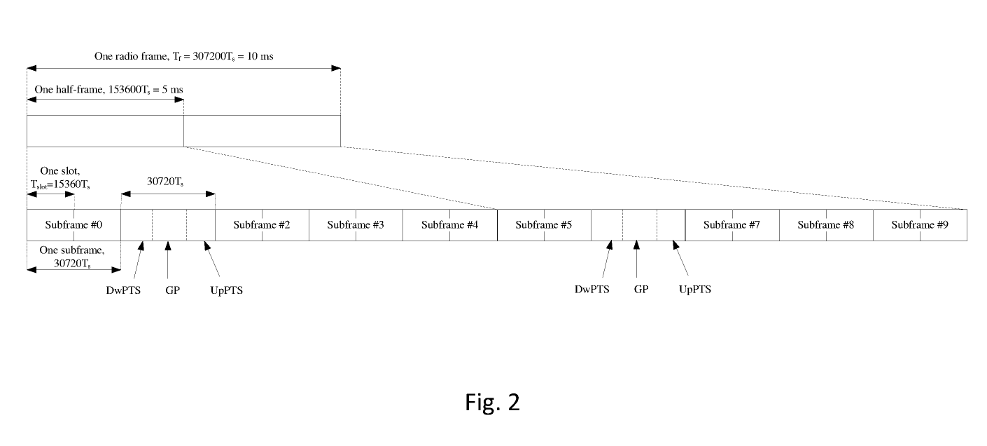

The frame structure type 2, applicable for TDD, is as shown in FIG. 2.

UL/DL TDD configurations are discussed in the following.

The table below shows UL/DL TDD configurations defined so far in 3GPP LTE, where, for each subframe in a radio frame, “D” denotes the subframe is reserved for downlink transmissions, “U” denotes the subframe is reserved for uplink transmissions and “S” denotes a special subframe with the three fields DwPTS, GP (TDD guard period), and UpPTS. Choosing a specific UL/DL configuration may be determined e.g. by traffic demand in DL and/or UL and network capacity in DL and/or UL.

| Uplink- | Downlink- | | | | | | | | | | |
|---|---|---|---|---|---|---|---|---|---|---|---|
| downlink | to-Uplink | | | | | | | | | | |
| config- | Switch-point | Subframe number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Subframes 0 and 5 and DwPTS are always reserved for downlink transmission. UpPTS and the subframe immediately following the special subframe are always reserved for uplink transmission.

The length of DwPTS and UpPTS depends on the combination of DL and UL cyclic prefix lengths and on the special subframe configuration (10 pre-defined special subframe configurations are defined in TS 36.211). Typically, DwPTS is longer than UpPTS.

In case multiple cells or carriers are aggregated, the UE may assume that the guard period of the special subframe in the different cells have an overlap of at least 1456·T_{S}.

Simultaneous Transmission and Reception in TDD is discussed in the following.

A UE may need to perform simultaneous transmission/reception in a TDD system in e.g.

Inter-band scenario, i.e., when an UL subframe/slot/UpPTS is configured in at least one cell on a carrier frequency in one band and a DL subframe/slot/DwPTS is configured in at least one cell on another carrier frequency in another band, wherein the UL and DL subframe/slot or other signals configured on different cells of different carriers in different bands at least partly overlap in time,

Inter-frequency scenario, i.e., when an UL subframe/slot/UpPTS is configured in at least one cell on one carrier frequency and a DL subframe/slot/DwPTS is configured in at least one cell on another carrier frequency, where the carrier frequencies belong to the same frequency band, wherein the UL and DL subframe/slot or other signals configured on different cells of different carriers in the same band at least partly overlap in time,

Intra-frequency scenario, i.e., when when an UL subframe/slot/UpPTS is configured in one cell and a DL subframe/slot/DwPTS is configured in another cell on the same carrier frequency, wherein the UL and DL subframe/slot or other signals configured on different cells of the same carrier at least partly overlap in time,

The different configurations may occur statically, semi-statically (e.g., with inter-band CA), or dynamically (e.g., with dynamic TDD).

The different carriers in the same or different bands mentioned in above scenarios may also belong to multicarrier configuration of the UE e.g. f1 and f2 may be PCC and SCC of the UE.

It may be resource and complexity demanding to require that all UEs are capable of simultaneous transmission and reception. Therefore, to address this issue for the inter-band scenario, 3GPP has specified the following UE capability, which is provided as an example:

TS 36.331 (Rel-11):

```
BandCombinationParameters-v1130 ::= SEQUENCE {
  multipleTimingAdvance-r11 ENUMERATED {supported} OPTIONAL,
  simultaneousRx-Tx-r11 ENUMERATED {supported} OPTIONAL,
  bandParameterList-r11 SEQUENCE (SIZE
  (1..maxSimultaneousBands-r10))
OF BandParameters-v1130 OPTIONAL,
  ...
}
simultaneousRx-Tx
```

Indicates whether the UE supports simultaneous reception and transmission on different bands for each band combination listed in supportedBandCombination. This field is only applicable for inter-band TDD carrier aggregation.

TS 36.306 (Rel-11):

4.3.5.4 SimultaneousRx-Tx

This field defines whether the UE supports simultaneous reception and transmission for inter-band TDD carrier aggregation.

When different UL/DL subframe configurations occur, e.g. in the intra-frequency, inter-frequency, and inter-band scenarios, one or more of the following may be relevant:

Not all UEs may be supporting simultaneous transmission/reception and not all network nodes may be aware of this, e.g., the simultaneous Tx-Rx capability was introduced in Rel-11 but there may be Rel-10 UEs and Rel-10 eNodeBs.

The simultaneous Rx-Tx capability may only apply to CA. However, a UE capable of simultaneous transmission/reception in CA may be currently not configured with CA and as a result the UE may be not able to perform simultaneous transmission/reception, unless it is configured with CA. Furthermore, the CA configuration of a UE is dynamically configured, which may additionally impact in a dynamic manner the UE's ability to simultaneously transmit/receive.

If the network does not properly account for the individual UE capability to support simultaneous transmission/reception, the UE without such capability may be not able to

transmit some signals and/or channels that it is expected (e.g., scheduled) to transmit, or

receive some signals and/or channels that it is expected (e.g., according to a pre-defined requirement) to receive or perform a measurement, and as a result, it will degrade its performance. In more specific examples,

### EXAMPLE 1

To enable DL reception in certain subframe (say SB1) on f1, if the UE is not scheduled to transmit critical UL signals or schedule to transmit such signals in UL with reduced rate in the same subframe (SB1) on f2 then certain measurements relying on such UL signals will be degraded e.g. measurements using SRS such as eNode B Rx-Tx, UE Rx-Tx, SINR at eNode B etc.

### EXAMPLE 2

To enable UL transmission in certain subframe (say SB1) on f1, if the UE is not scheduled to receive critical DL signals or schedule to transmit such signals in DL with reduced rate in the same subframe (SB1) on f2 then certain measurements/procedures relying on such DL signals will be degraded e.g. measurements using CRS etc.

Generally, a UE (e.g., in a method for operating a UE) may transmit and receive simultaneously, and/or be adapted to and/or comprise a radio module adapted to, transmit and receive simultaneously, e.g. on one carrier or cell (e.g. full-duplex) and/or on one or more than one carriers or cells (e.g. when configured with a first cell and a second cell, wherein the first and second cell may be associated to the same carriers). A subframe may be associated to a cell or CA. Each signalling in a subframe may have associated to it a direction of transmission, e.g. UL or DL and/or to a node or from a node (or both, in some full-duplex arrangements), which may be associated to the subframe. In particular, an UL subframe (or a special subframe) may be considered to have an UL direction.

A measurement subframe may be a subframe scheduled for measurement, e.g. in which dedicated measurement signalling is scheduled, e.g. positioning signalling. A measurement subframe configuration may indicate the scheduling of one or more measurement subframes. To a measurement subframe or measurement signalling there may be generally associated a direction of transmission, namely the direction of the measurement signalling (e.g. UL or DL and/or to a node or from a node).

A positioning subframe (which is an example of a measurement subframe) may be a subframe comprising positioning signalling (in particular DL signalling), e.g. corresponding to one or more reference signals like PRS (Positioning Reference Signal/s). A positioning subframe and/or a positioning subframe configuration (which is an example of a measurement subframe configuration) may be determined and/or configured by a network node, e.g. during scheduling. A network node may be adapted for such determining and/or configuring and/or comprise a determining and/or configuring module for such determining and/or configuring. A positioning subframe configuration may represent a schedule of at least one positioning subframe within one or more than one radio frames. It may be represented by allocation data and/or configuration information, which may be transmitted and/or configured to a UE. Positioning subframes may be distributed apart from each other in a frame or scheduling time interval, and/or at least some, e.g. up to 5, may be arranged consecutively.

Configuring a radio node or UE (e.g. by a correspondingly adapted network node and/or a correspondingly adapted node configuring module of a network node) with one or more measurement or positioning subframes and/or a measurement or positioning subframe configuration may comprise providing corresponding data (e.g. allocation data) to the radio node or UE indicating that and/or when measurement or positioning subframes are scheduled. Generally, one or more measurement positioning subframes may be included in and/or determined and/or indicated and/or identified by a corresponding measurement or positioning subframe configuration.

Generally, there may be considered a method for operating a network node, the method comprising determining one or more measurement subframes, e.g. positioning subframes, and/or a measurement subframe configuration, e.g. a positioning subframe configuration. The (measurement or positioning) subframes and/or the (measurement or positioning) subframe configuration may pertain to one or more first cell/s and/or carrier/s (cells and/or carriers in particular in the context of CA) associated and/or connected to a first radio node, in particular a UE, which may be adapted for and/or operable or operated with simultaneous transmission and reception (TX-RX) on at least a first carrier or frequency. Determining subframe/s and/or subframe configuration may be based on a schedule and/or configuration and/or allocation data (in particular, the UL-DL configuration) of a second cell, which may be associated to a second radio node (e.g. a network node or UE).

The second radio node may be the first radio node or be different. The second cell may be associated to at least one shared carrier/s. In particular, the first cell may share at least a first carrier (which may be a carrier the first radio node is adapted for simultaneous TX-RX) with the second cell, e.g. a first UL carrier and/or a first DL carrier. There may be considered a network node adapted for such determining (of subframe/s and/or a subframe configuration) and/or comprising a determining module for such determining. The method may comprise, and/or the network node may be adapted for and/or comprise a node configuring module for, configuring the first radio node (or UE) with the (measurement or positioning) subframe configuration and/or the one or more (measurement or positioning) subframes. The determining and/or adapting and/or scheduling may be performed such that at least one or more than one and/or as many as possible and/or each (measurement or positioning) subframe/s of the corresponding configuration (pertaining to the first cell) is/are arranged and/or scheduled and/or determined and/or configured to coincide and/or coincide/s with subframe/s of the second cell having the same direction of transmission and/or to avoid and/or lower and/or limit coincidence with subframe/s of the second cell having different direction of transmission.

A first UL-DL configuration may be associated to the first cell. A second UL-DL configuration may be associated to the second cell.

Determining the (measurement or positioning) subframe/s and/or the (measurement or positioning) subframe configuration may comprise corresponding adapting and/or scheduling.

It may be considered that the method comprises, and/or that the network node is adapted for and/or comprises a configuration determining module for, determining whether and/or that the first UL-DL configuration and the second UL-DL configuration are different. Determining the subframe/s and/or subframe/s configuration may be based upon such determining pertaining to the first UL-DL configuration and the second UL-DL configuration (e.g., determining the subframe/s and/or subframe/s configuration may be performed if the first UL-DL configuration and the second UL-DL configuration are determined to be different).

For example, there may be considered a method for operating a network node, wherein the network node adapts a measurement/positioning subframe configuration in one or more first cells associated with a first radio node, in particular to reduce or avoid the overlap in time of the measurement/positioning subframes with special subframes or UL subframes in a second cell, which may be associated with a second radio node, in particular while ensuring a sufficient number of positioning subframes are available for positioning measurements by a first UE. There may be considered a corresponding network node adapted for such method and/or adapting and/or comprising a corresponding determining and/or configuring module.

There may be considered a method for operating a UE. The method may comprise receiving (e.g., by the UE), a measurement or positioning configuration (and/or receiving corresponding allocation data), e.g. from a network or a network node as described herein. The measurement and/or positioning configuration may be as described herein. There may be considered a UE adapted for such receiving and/or comprising a corresponding receiving module. The method may comprise operating (in particular performing measurements) the UE based on the configuration received. The UE may be adapted for such operating and/or may comprise a corresponding operating module. Operating in particular may comprise operating the UE with one direction of transmission during measurement or positioning subframes configured by the configuration.

### EXAMPLE SCENARIO 1

The first cell uses TDD or HD-FDD and the second cell uses TDD or HD-FDD, and the first and the second cells use a first UL-DL configuration and a second UL-DL configuration, respectively, which are different during a time period comprising also at least one of the positioning subframes of the first cell.

### EXAMPLE SCENARIO 2

The first cell uses FDD and the second cell uses TDD or HD-FDD during a time period comprising also at least one of the positioning subframes of the first cell. Herein, the UL-DL configuration for an FDD DL frequency may be such (and the term ‘UL-DL configuration’ is broader than that specified in 3GPP TS 36.211) that all subframes are DL, from a positioning perspective when positioning subframes are DL subframes.

There may be considered a method for operating a first network node, and/or a first network node adapted for and/or comprising a configuration determining module for, any one or any combination of the following actions:

Determining that at least a first and a second UL-DL configurations are used in at least one first and a second cells respectively (e.g., on two different carriers), where the first and the second UL-DL configurations are different;

NOTE: this step is optional, in particular in the context of Example scenario 2 (as the UL-DL configurations are indeed automatically different for FDD and TDD) once the duplex modes are known.

Adapting or determining (e.g. by a correspondingly adapted network node or a determining module of the network node)

A measurement or positioning subframe configuration in at least one cell, and/or

at least one of the first and the second UL-DL configurations during at least one frame which at least partly overlaps in time with a measurement positioning occasion containing at least one measurement or positioning subframe (e.g. PRS subframes). NOTE: Adapting the first UL-DL configuration may not be applicable/necessary in the example scenario 2.

Any one or both of the above adaptions may be performed to enable:

the measurement or positioning subframes in the first cell and subframes in the second cell overlapping with the measurement or positioning subframes are transmitted in the same direction, or

the first set of measurement or positioning subframes in the first cell and a second set of measurement or positioning subframes in the second cell overlapping at least in part with the first set of measurement or positioning subframes are transmitted in the same direction.

Some Generalizations are discussed in the following:

Different UL/DL configurations may comprise, e.g., any one or more of:

(e.g., in an inter-band scenario), an UL configuration in at least one cell on a carrier frequency in one band and a DL configuration in at least one cell on another carrier frequency in another band, wherein the UL and DL configuration in different cells of different carriers in different bands at least partly overlap in time,

(e.g., in an inter-frequency scenario), an UL configuration in at least one cell on one carrier frequency and a DL configuration in at least one cell on another carrier frequency, where the carrier frequencies belong to the same frequency band, wherein the UL and DL configurations in different cells of different carriers in the same band at least partly overlap in time,

Intra-frequency scenario, an UL configuration in one cell and a DL configuration in another cell on the same carrier frequency, wherein the UL and DL configurations in different cells of the same carrier at least partly overlap in time.

One or both of the two different UL/DL configurations may occur statically, semi-statically (e.g., with inter-band CA), or dynamically (e.g., with dynamic TDD).

The different carriers in the same or different bands mentioned in above scenarios may also belong to multicarrier configuration of the UE e.g. f1 and f2 may be PCC and SCC of the UE.

A configuration of a UE may generally refer to a setting and/or operational state of the UE, e.g. in regards of cell/s and/or carrier/s and/or frequencies used for communication. A configuration may be configured e.g. by a network and/or network node, for example by transmitting corresponding configuration information and/or allocation data to the UE.

Additionally or alternatively, an UL configuration may comprise, e.g., one or more of:

UL subframe, UL slot, UpPTS, UL symbol, any time period or time unit intended for transmissions by a UE; and/or DL configuration may comprise, e.g., one or more of:

DL subframe, DL slot, DwPTS, DL symbol, any time period or time unit intended for transmitting radio signals by a radio network node (e.g., eNodeB) and/or receiving radio signals by a UE.

An UL-DL configuration may comprise an UL configuration and a DL configuration. It may be considered that an UL-DL configuration comprises and/or indicates one or more measurement subframe/s (in particular positioning subframe/s). Accordingly, a UL-DL configuration may be an example of a measurement or positioning subframe configuration.

The UL and DL configurations may be different (or it may be relevant or determined that they are different) when they are overlap in time, at least partly. For example, two different TDD UL/DL configurations in PCell and SCell result in that there is at least one time instance in which one of the two cells has an UL configuration (e.g., an UL subframe or UpPTS) and the other one has a DL configuration (e.g., a DL subframe or DwPTS) at the same time, even if the TDD configurations are frame- or subframe-aligned in time. Another example is when a special subframe is configured in one cell and a DL or an UL configuration is configured in another cell at the same time (a special subframe contains an UL configuration, a guard period, and a DL configuration, and thus an overlap of the UL part or the guard period of the special subframe in one cell with the DL subframe of the cell would result in a loss in the prior art as well as an overlap of the DL part or the guard period of the special subframe in one cell with the UL subframe in the other cell).

UE in some embodiments herein, may comprise any entity capable of at least receiving or transmitting radio signals either via a direct link (e.g., between two UEs) or a link to a radio network or both. A UE may comprise a radio receiver, a cellular UE, a wireless device, a PDA, laptop, a mobile, a sensor, a relay, a D2D relay, or even a small BS or a radio network node or another device employing a UE-like interface, etc.

A network node may be a radio network node or another network node. Some examples of the radio network node are a radio base station, a relay node, an access point, a cluster head, RRH, DAS, RNC, etc. The radio network node is comprised in a wireless communication network and may also support cellular operation. Some examples of a network node which is not a radio network node: a core network node, SON node, O&M node, positioning node, a server, an application server, an external node, or a node comprised in another network. A radio node may generally comprise a UE or a radio network node.

Signaling (or transmitting) herein, at least in some embodiments, may comprise signaling via higher layer or physical layer, via direct link or logical link (e.g., via another node, another network node, device, hop, etc.), via radio and/or fixed interface, via control plane and/or user plane.

Some examples of critical DL (radio) signals/channels: PSS/SSS, PBCH, SIB1, channel with system information (SI) data, sparsely transmitted reference signals (e.g., PRS transmitted in positioning occasions with periodicity of at least 160 ms), control channels, DL channels comprising grants for UL transmissions or UL transmission configuration for a UE, any radio signal sparsely transmitted, DwPTS. The DL signals/channels may be unicast, multicast or broadcast.

Some examples of critical UL (radio) signals/channels: SRS, D2D-related radio signals/channels transmitted in the UL spectrum, UL channels with ACK/NACKs to DL receptions received by the UE, any sparsely transmitted radio signal/channel, random access transmission resource or opportunity e.g. UpPTS. The UL signals/channels may be unicast, multicast or broadcast (e.g., with D2D communication).

The embodiments described herein may be combined with each other in any way.

Methods in a network node of adapting a positioning subframe configuration are discussed in the following.

Embodiments in this section may be combined in any way with embodiments described in other sections.

There is suggested a method for operating a network node comprising, and/or a network node adapted for and/or comprising an adapting module for, adapting a positioning subframe configuration in one or more first cells associated with a first radio node, e.g. to reduce or avoid the overlap in time of the positioning subframes with special subframes or UL subframes in a second cell associated with a second radio node, while ensuring a sufficient number of positioning subframes are available for positioning measurements by a first UE.

### EXAMPLE SCENARIO 1

The first cell uses TDD or HD-FDD and the second cell uses TDD or HD-FDD, and the first and the second cells use a first UL-DL configuration and a second UL-DL configuration, respectively, which are different during a time period comprising also at least one of the positioning subframes of the first cell.

### EXAMPLE SCENARIO 2

The first cell uses FDD and the second cell uses TDD or HD-FDD during a time period comprising also at least one of the positioning subframes of the first cell. Herein, the UL-DL configuration for an FDD DL frequency is trivial—all subframes are DL, from positioning perspective when positioning subframes are DL subframes.

Herein, in some non-limiting examples, any one or more of the below may apply:

the network node is

the same as the first radio node, or

different from the first radio node;

the first and the second radio node are

the same, or

different,

the first and the second cells are on a first and a second carrier frequency, respectively,

the first cell associated with the first radio node is

a serving cell (e.g., a PCell or SCell) of the first UE, or

a non-serving neighbor cell for the first UE;

the second cell associated with the second radio node is

a serving cell (e.g., a PCell or SCell) of the first UE, or

a non-serving neighbor cell for the first UE;

some examples of the network node: positioning node (e.g., E-SMLC in LTE), coordinating node (e.g., SON node or O&M) or radio network node,

some example of the first or second radio node: radio network node (e.g., base station or eNodeB or access point), wireless device, or a second UE,

the sufficient number of positioning subframes is characterized by one or more of:

a number above a certain threshold (e.g., at least 2 positioning subframes per positioning occasion wherein 2 is the threshold in this example), wherein the threshold may be pre-defined or configurable,

the number of positioning subframes comprised in a radio frame, in a positioning occasion, in a positioning period, or within positioning measurement time,

dependent on a bandwidth (e.g., of positioning signals, of the first set of transmissions, or of the second set of transmissions),

a pre-defined number or defined based on pre-defined rule, or

determined based on a quality metric or to ensure a certain positioning quality of service,

configurable (e.g., by the network node, the first radio node, other network node, other radio node, or other node), or

received by the network node from the first UE or from the first radio node or from another node.

A basic embodiment comprises the following steps in a first network node:

Step 1: Determining that different UL-DL configurations are used in at least two cells (this step may be skipped, e.g. in the FDD case);

Step 2: Adapting or determining

a positioning subframe configuration on at least one cell to avoid or reduce simultaneous transmission and reception on different cells for the UE (e.g., adapting the positioning configuration such that a positioning subframe (e.g. subframe 3) in one direction (e.g. in DL) on a first cell does not overlap in time with the corresponding same subframe (e.g. subframe 3) in an opposite direction (e.g. in UL) on a second cell in a frame-aligned system), and/or

UL-DL configuration in at least one cell during the positioning occasions e.g. frames where positioning subframe are transmitted by the first network node and/or received at the first network node.

The adaptation or determination may be performed statically, semi-statically, or dynamically.

A measurement or positioning subframe may comprise any one or more of:

Subframe for positioning measurements, e.g., RSTD measurements, E-CID measurements, AECID measurements, RFPM measurements;

Subframe comprised in a positioning occasion e.g. OTDOA positioning occasion containing one or more subframes with PRS signals;

Subframe with positioning-specific signals, e.g., with PRS. Determining that different UL-DL configurations are used in at least two cells (e.g. serving cells) may be based on and/or comprise one or more of the following mechanisms:

retrieving information from a memory about the configured UL-DL configurations used in two or more cells and/or

receiving information from another network node (e.g., another eNodeB, positioning node, O&M, SON, a coordinating node, etc.) and/or from one or more UEs about the configured UL-DL configurations used in two or more cells and/or

obtaining information based on historical data e.g. UL-DL configurations used in different cells in the last M seconds etc.

As an example the above retrieved, received or obtained formation may comprise of:

UL-DL configurations #0 and #1 are used in PCell and SCell respectively and/or

UL-DL configurations #0 and #1 are used on 2 or more cells of PCC and SCC respectively and/or

UL-DL configurations #0 and #1 are used in SCell1 and SCell 2 and/or UL-DL configurations #0 and #1 are used on 2 or more cells of SCC1 and SCC2 respectively.

Determining or adapting of the (measurement or positioning) subframe/s and/or subframe configuration on at least one (the first) cell can be performed based on one or more of the following principles:

Adapting in semi-static manner whenever there is any change in PRS configuration and/or in UL-DL configurations and/or one or more new cells using different UL-DL configuration are added in the network and/or one or more new TDD cells are in,

Adapting in dynamic manner when the first network node determines that the positioning subframe configuration is used by the UE for positioning measurements.

Adaptation upon determining that there is at least one UE without simultaneous RxTx capability which may perform positioning measurements on the first cell, wherein the UE may or may not be served by the first radio node

Adaptation is performed when the overlap is above a threshold, e.g., when >M positioning subframes may be lost.

Adaptation is performed when the number of available subframes is below a threshold, e.g., <K, and may be insufficient for positioning for one or more first UEs.

The adapting or determining of (measurement or positioning) subframe configuration may comprise, e.g., any one or more of:

Changing one or more of: transmission bandwidth for positioning signals, number of positioning subframes per positioning occasion, positioning occasion periodicity, time shift of a positioning occasion (e.g., subframe shift of the first positioning subframe with respect to subframe #0), muting pattern of signals used for positioning, muting pattern of signals interfering with the signals used for positioning, positioning signal pattern in the time-frequency domain, signal type to be used for positioning (e.g., depending on the signal density: PRS has higher density per subframe, CRS has lower density but transmitted in every subframe, CSI-RS has the lowest density)

avoiding configuring certain configurations e.g. avoiding configuring more than 3 positioning subframes in one positioning occasion. This may make it easier for the first network node to avoid configuring in a cell the positioning subframes which are in opposite direction with respect to the same subframes in at least one another cell,

changing a configuration e.g. changing from a PRS subframe configuration with 4 DL PRS subframes in a positioning occasion to another PRS subframe configuration with 2 DL PRS subframes in a positioning occasion,

configuring a configuration based on a pre-defined rule (see Section “Example Rules”),

reversing the current configuration,

ensuring that configuration is in a specific direction e.g. DL subframe in two or more cells for certain subframes e.g. DL subframes #0 and #5,

avoiding loosing critical UL signals/channels,

avoiding loosing critical DL signals/channels.

The adapting and/or configuring of UL-DL subframe configuration during the time overlapping with a positioning occasion in at least one cell may comprise, e.g., any one or more of:

performing adaptation to enable the use of the same UL-DL subframe configurations in one or more frames partly or fully overlapping with a positioning occasion (i.e. subframes containing positioning subframes such as PRS subframes) in two or more cells,

performing adaptation to enable the use of the UL-DL subframe configurations in two or more cells such that at least certain number of positioning subframes in a positioning occasion (i.e. subframes containing positioning subframes such as PRS subframes) can be configured in at least one cell e.g. 3 DL PRS subframes per positioning occasion.

Further, the network node may perform and/or be adapted to perform one or more of the following additional actions:

Sending the adapted configuration to a second node e.g. to another network node such as eNode B or to a positioning node;

Prior to the adapting, determining whether there is or there may be expected at some point at least one UE performing RSTD measurement, wherein

the UE may be in the cell controlled by the first node, or

the UE may be in a cell not controlled by the first node;

Prior to the adapting, determining whether there is or there may be expected at some point at least one UE performing RSTD measurement, where the at least one UE does not have the capability of simultaneous tx/rx, wherein

the UE may be in the cell controlled by the first node, or

the UE may be in a cell not controlled by the first node;

Determining the number N of measurement or positioning subframes for meeting a measurement or positioning performance target (see also “Example Rules”).

Adapting the measurement or positioning subframe configuration on at least one cell served by the first network node, in response to an explicit request received from another node e.g. from the UE, positioning node, eNode B etc.

Adapting the measurement or positioning subframe configuration on at least one cell served by the first network node, in response to determining that in the cell there is at least one UE which is not capable of simultaneous RX/TX on different cells i.e. the UE does not support simultaneous reception and transmission on different bands for inter-band TDD carrier aggregation. The first network node can determine the UE capability of not supporting simultaneous RX/TX operation for example based on explicit indication received from the UE, historical date, etc. Some examples of the first and the second node are respectively:

o eNodeB and positioning node (e.g., E-SMLC);

o positioning node (e.g., E-SMLC) and eNodeB;

o first radio network node (e.g., eNodeB) and second radio network node (e.g., eNodeB, RRH, a slave radio network node with respect to the first eNodeB, etc.);

controlling node (e.g., SON or O&M) and eNodeB;

controlling node (e.g., SON or O&M) and positioning node;

eNodeB and UE;

positioning node and UE (e.g., in the OTDOA assistance data).

Example rules related to adapting/determining a configuration are discussed in the following.

Herein, some example rules for performing the adaptation are provided:

Adapting the measurement or positioning subframes may comprise configuring the positioning subframes in a cell in pre-defined DL subframes and/or subframes that are not expected to overlap in time with special or UL subframes in another cell, e.g., configuring positioning subframes only in subframes #0 and/or #5.

Adapting measurement or positioning subframes may comprise adapting the measurement or positioning subframe configuration so that at least N measurement or positioning subframes are available for measurements, in particular positioning measurements, wherein “available” may comprise:

Non-overlapping in time with special or UL subframe, or

Subframes where the UE is not scheduled, is allowed to not transmit even if scheduled, or does not transmit for any other reason.

Adapting the measurement or positioning subframe configuration so that at least N positioning subframes are available for positioning measurements for a specific group of UEs in an occasion (e.g., for UEs without the simultaneous TxRx capability)

Non-overlapping with special or UL subframe, or

Subframes where the UE is not scheduled, is allowed to not transmit even if scheduled, or does not transmit for any other reason.

Adapting the measurement or positioning subframe configuration so that at most M measurement or positioning subframes may be lost, e.g., per measurement or positioning occasion

Adapting the measurement or positioning subframe configuration so that at least K measurement or positioning subframes are available per positioning occasion, where:

K=number of DL subframes which overlap in all cells using different UL-DL TDD configurations. In an example assume UL-DL configurations # 1 and # 2 are used in cell1 and cell2 respectively. In this case the first network node will use at most DL subframes #0, #4, #5 and #9 for transmitting PRS in cell 1 as well as in cell 2. In this way in both cells the PRS subframes (#0, #4, #5 and #9 ) in one cell will not overlap with any UL subframe in the other cell.

| Uplink- | Downlink- | | | | | | | | | | |
|---|---|---|---|---|---|---|---|---|---|---|---|
| downlink | to-Uplink | | | | | | | | | | |
| config- | Switch-point | Subframe number | | | | | | | | | |
| uration | periodicity | 0 | 1 | 2 | 3 | 4 | 5 | 6 | 7 | 8 | 9 |
| 1 | 5 ms | D | S | U | U | D | D | S | U | U | D |
| 2 | 5 ms | D | S | U | D | D | D | S | U | D | D |

Adapting UL-DL subframe configuration in a measurement or positioning occasion in at least one cell may be performed as follows: Assume that UL-DL configurations # 0 and # 1 are configured in cell1 and cell2 respectively. The positioning occasion comprises of one frame occurring every 320 ms. As an example during the measurement or positioning occasion, the first network node may change the UL-DL configuration # 0 in cell1 to UL-DL configuration # 1 and transmit 4 DL PRS subframes in cent and after the measurement or positioning occasion the first network node may revert the UL-DL configuration from configuration # 1 to # 0 in cell1.

One or more rules based on the above examples can be pre-defined in the standard. Yet additional examples of such rules are:

When certain type of measurement or positioning subframes are used or when UE is configured to perform measurements, e.g. positioning measurements, on certain type of positioning signals, and different UL-DL configurations are used on at least two cells (e.g. PCell and SCell, SCells etc) or CCs (e.g. PCC and SCC, SCCs etc) then the measurement or positioning subframes in a first cell and the same corresponding subframes in another cell, are have the same direction e.g. all subframes in cell2 overlapping in time with PRS subframes in cell1 are DL subframes.

The UE may assume that even when different UL-DL configurations are used on at least two cells (e.g. PCell and SCell, SCells etc) or CCs (e.g. PCC and SCC, SCCs etc), and when UE is configured to perform measurements, e.g. positioning measurements, in measurement or positioning subframes, then the UE may assume that at least during the measurement or positioning occasion, the PRS subframes in one cell overlap with DL subframes or PRS subframes in other cell(s).

The UE may assume that even when different UL-DL configurations are used on at least two cells (e.g. PCell and SCell, SCells etc) or CCs (e.g. PCC and SCC, SCCs etc), and when UE is configured to perform measurement or positioning measurements in measurement or positioning subframes, then the UE may assume that at least during the measurement or positioning occasion, the same UL-DL configuration is used in at least two cells or CCs e.g. on PCell and SCell, on two SCells etc.

In the context of this description, wireless communication may be communication, in particular transmission and/or reception of data, via electromagnetic waves and/or an air interface, in particular radio waves, e.g. in a wireless communication network and/or utilizing a radio access technology (RAT). The communication may involve one or more than one terminal connected to a wireless communication network and/or more than one node of a wireless communication network and/or in a wireless communication network. It may be envisioned that a node in or for communication, and/or in, of or for a wireless communication network is adapted for communication utilizing one or more RATs, in particular LTE/E-UTRA. A communication may generally involve transmitting and/or receiving messages, in particular in the form of packet data. A message or packet may comprise control and/or configuration data and/or payload data and/or represent and/or comprise a batch of physical layer transmissions. Control and/or configuration data may refer to data pertaining to the process of communication and/or nodes and/or terminals of the communication. It may, e.g., include address data referring to a node or terminal of the communication and/or data pertaining to the transmission mode and/or spectral configuration and/or frequency and/or coding and/or timing and/or bandwidth as data pertaining to the process of communication or transmission, e.g. in a header. Each node or terminal involved in communication may comprise radio circuitry and/or control circuitry and/or antenna circuitry, which may be arranged to utilize and/or implement one or more than one radio access technologies. Radio circuitry of a node or terminal may generally be adapted for the transmission and/or reception of radio waves, and in particular may comprise a corresponding transmitter and/or receiver and/or transceiver, which may be connected or connectable to antenna circuitry and/or control circuitry. Control circuitry of a node or terminal may comprise a controller and/or memory arranged to be accessible for the controller for read and/or write access. The controller may be arranged to control the communication and/or the radio circuitry and/or provide additional services. Circuitry of a node or terminal, in particular control circuitry, e.g. a controller, may be programmed to provide the functionality described herein. A corresponding program code may be stored in an associated memory and/or storage medium and/or be hardwired and/or provided as firmware and/or software and/or in hardware. A controller may generally comprise a processor and/or microprocessor and/or microcontroller and/or FPGA (Field-Programmable Gate Array) device and/or ASIC (Application Specific Integrated Circuit) device. More specifically, it may be considered that control circuitry comprises and/or may be connected or connectable to memory, which may be adapted to be accessible for reading and/or writing by the controller and/or control circuitry. Radio access technology may generally comprise, e.g., Bluetooth and/or Wifi and/or WIMAX and/or cdma2000 and/or GERAN and/or UTRAN and/or in particular E-Utran and/or LTE. A communication may in particular comprise a physical layer (PHY) transmission and/or reception, onto which logical channels and/or logical transmission and/or receptions may be imprinted or layered.

A node of a wireless communication network may be implemented as a terminal and/or user equipment and/or network node and/or base station (e.g. eNodeB) and/or relay node and/or any device generally adapted for communication in a wireless communication network, in particular cellular communication. A node adapted for radio and/or wireless communication may be considered to be a radio node.

A wireless communication network or cellular network may comprise a network node, in particular a radio network node, which may be connected or connectable to a core network, e.g. a core network with an evolved network core, e.g. according to LTE. A network node may e.g. be a base station. The connection between the network node and the core network/network core may be at least partly based on a cable/landline connection. Operation and/or communication and/or exchange of signals involving part of the core network, in particular layers above a base station or eNB, and/or via a predefined cell structure provided by a base station or eNB, may be considered to be of cellular nature or be called cellular operation.

A terminal may be implemented as a user equipment; it may generally be considered that a terminal is adapted to provide and/or define an end point of a wireless communication and/or for a wireless communication network. A terminal or a user equipment (UE) may generally be a device configured for wireless device-to-device communication and/or a terminal for a wireless and/or cellular network, in particular a mobile terminal, for example a mobile phone, smart phone, tablet, PDA, etc. A user equipment or terminal may be a node of or for a wireless communication network as described herein, e.g. if it takes over some control and/or relay functionality for another terminal or node. It may be envisioned that terminal or user equipment is adapted for one or more RATs, in particular LTE/E-UTRA. It may be considered that a terminal or user equipment comprises radio circuitry and/control circuitry for wireless communication. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. It may be considered that a terminal or user equipment is configured to be a terminal or user equipment adapted for LTE/E-UTRAN. Generally, a terminal may be adapted to support dual connectivity. It may comprise two independently operable transmitter (or transceiver) circuitries and/or two independently operable receiver circuitries; for dual connectivity, it may be adapted to utilize one transmitter (and/or receiver or transceiver, if provided) for communication with a master network node and one transmitter (and/or receiver or transceiver, if provided) for communication with a secondary network node. It may be considered that a terminal comprises more than two such independently operable circuitries.

A network node or base station, e.g. an eNodeB, may be any kind of base station of a wireless and/or cellular network adapted to serve one or more terminals or user equipments. It may be considered that a base station is a node or network node of a wireless communication network. A network node or base station may be adapted to provide and/or define and/or to serve one or more cells of the network and/or to allocate frequency and/or time resources for communication to one or more nodes or terminals of a network. Generally, any node adapted to provide such functionality may be considered a base station. It may be considered that a base station or more generally a network node, in particular a radio network node, comprises radio circuitry and/or control circuitry for wireless communication. It may be envisioned that a base station or network node is adapted for one or more RATs, in particular LTE/E-UTRA . Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. A base station may be arranged to be a node of a wireless communication network, in particular configured for and/or to enable and/or to facilitate and/or to participate in cellular communication, e.g. as a device directly involved or as an auxiliary and/or coordinating node. Generally, a base station may be arranged to communicate with a core network and/or to provide services and/or control to one or more user equipments and/or to relay and/or transport communications and/or data between one or more user equipments and a core network and/or another base station. A network node or base station may generally be adapted to allocate and/or schedule time/frequency resources of a network and/or one or more cells serviced by the base station. An eNodeB (eNB) may be envisioned as an example of a base station, e.g. according to an LTE standard. It may be considered that a base station is configured as or connected or connectable to an Evolved Packet Core (EPC) and/or to provide and/or connect to corresponding functionality. The functionality and/or multiple different functions of a base station may be distributed over one or more different devices and/or physical locations and/or nodes. A base station may be considered to be a node of a wireless communication network. Generally, a base station may be considered to be configured to be a controlling node and/or coordinating node and/or to allocate resources in particular for cellular communication via one or more than one cell.

It may be considered for cellular communication there is provided at least one uplink (UL) connection and/or channel and/or carrier and at least one downlink (DL) connection and/or channel and/or carrier, e.g. via and/or defining a cell, which may be provided by a network node, in particular a base station or eNodeB . An uplink direction may refer to a data transfer direction from a terminal to a network node, e.g. base station and/or relay station. A downlink direction may refer to a data transfer direction from a network node, e.g. base station and/or relay node, to a terminal. UL and DL may be associated to different frequency resources, e.g. carriers and/or spectral bands. A cell may comprise and/or be defined by at least one uplink carrier and at least one downlink carrier, which may have different frequency and/or frequency bands, or may have the same frequency or frequency band (e.g. for half-duplex; for full-duplex, a cell may comprise one carrier serving both as UL and DL carrier, thus defining a cell).

A network node (which may be a radio network node), e.g. a base station or eNodeB, may be adapted to provide and/or define and/or control one or more cells, e.g. a group of cells, which may be carrier aggregated (CA) cells. The group of cells may comprise at least one primary cell, which may be considered to be a member of the group and/or to be associated to the group. The cell group may comprise one or more secondary cells (it should be noted that every group may comprise secondary cells, not only a secondary group; the secondary in this context refers to being secondary to the primary cell of a group). A primary cell may be adapted and/or utilised for providing control information (in particular allocation data, and/or scheduling and/or allocation information regarding the primary cell and/or the group of cells to and/or from a terminal connected for communication (transmission and reception) and/or configured with the cell. The control information may pertain to the primary cell and/or the group of cells. Each primary cell and/or the associated group may be associated to a specific network node. A master network node may be adapted to provide and/or service and/or define a primary cell in a master cell group. A secondary network node may be adapted to provide and/or service and/or define a secondary cell group.

Generally, a network node may be a network node of and/or for a wireless or cellular communication network. A UE may be a UE of and/or for a wireless or cellular communication network.

A network node, in particular a base station, and/or a terminal, in particular a UE, may be adapted for communication in spectral bands (frequency bands) licensed and/or defined for LTE.

Resources or communication resources may generally be frequency and/or time resources, which may comprises e.g. frames, subframes, slots, resource blocks, carriers, subcarriers, channels, frequency/spectral bands, etc. Allocated or scheduled resources may comprise and/or refer to frequency-related information, in particular regarding one or more carriers and/or bandwidth and/or subcarriers and/or time-related information, in particular regarding frames and/or slots and/or subframes, and/or regarding resource blocks and/or time/frequency hopping information. Transmitting on allocated resources and/or utilizing allocated resources may comprise transmitting data on the resources allocated, e.g. on the frequency and/or subcarrier and/or carrier and/or timeslots or subframes indicated. It may generally be considered that allocated resources may be released and/or de-allocated. A network or a node of a network, e.g. a network node or allocation node, e.g. a base station, may be adapted to determine and/or transmit corresponding allocation or scheduling data, e.g. data indicating release or de-allocation of resources and/or scheduling of UL and/or DL resources. Accordingly, resource allocation may be performed by the network and/or by a network node; a network node adapted for providing resource allocation/scheduling for one or more than one terminals may be considered to be a controlling node. Resources may be allocated and/or scheduled on a cell level and/or by a network node servicing and/or providing the cell.

Allocation data may be considered to be data indicating and/or granting resources allocated by a network node, e.g. a controlling and/or allocation node, in particular data identifying or indicating which resources are reserved or allocated, e.g. for cellular communication, which may generally comprise transmitting and/or receiving data and/or signals; the allocation data may indicate a resource grant or release and/or resource scheduling. A grant or resource grant may be considered to be one example of allocation data. It may be considered that an allocation node is adapted to transmit allocation data directly to a node and/or indirectly, e.g. via a relay node and/or another node or base station. Allocation data may comprise control data and/or be part of or form a message, in particular according to a pre-defined format, for example a DCI format, which may be defined in a standard, e.g. LTE. In particular, allocation data may comprise information and/or instructions to reserve resources or to release resources, which may already be allocated. A UE may generally be adapted to perform transmission of data to, e.g. UL data, and/or reception of data from, a network node and/or to more than one network nodes, according to allocation data. Generally, allocation data may indicate and/or instruct transmission mode and/or configuration, in particular regarding a power level of transmission. A UE may generally be adapted for configuring itself according to allocation data, in particular to set a corresponding power level and/or timing of UL and DL operations. Generally, allocation data may represent a configuration, which may instruct and/or configure a UE for a specific behaviour or to use specific functionality or a parameter setting according to the configuration.

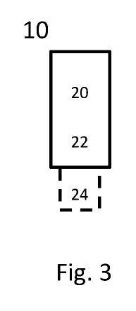

FIG. 3 schematically shows a user equipment 10. User equipment 10 comprises control circuitry 20, which may comprise a controller connected to a memory. Any module of a user equipment may implemented in and/or executable by, user equipment, in particular the control circuitry 20. User equipment 10 also comprises radio circuitry 22 providing receiving and transmitting or transceiving functionality, the radio circuitry 22 connected or connectable to the control circuitry. An antenna circuitry 24 of the user equipment 10 is connected or connectable to the radio circuitry 22 to collect or send and/or amplify signals. Radio circuitry 22 and the control circuitry 20 controlling it are configured for cellular communication with a network on a first cell /carrier and a second cell /carrier and/or for dual connectivity, in particular utilizing E-UTRAN/LTE resources as described herein. The user equipment 10 may be adapted to carry out any of the methods for operating a terminal disclosed herein; in particular, it may comprise corresponding circuitry, e.g. control circuitry.

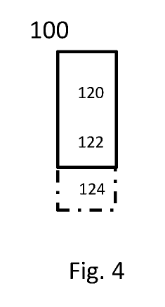

FIG. 4 schematically show a (radio) network node or base station 100, which in particular may be an eNodeB. Network node 100 comprises control circuitry 120, which may comprise a controller connected to a memory. Any module of a network node, e.g. a receiving module and/or transmitting module and/or control or processing module and/or scheduling module, may be implemented in and/or executable by the network node, in particular the control circuitry 120. The control circuitry 120 is connected to control radio circuitry 122 of the network node 100, which provides receiver and transmitter and/or transceiver functionality. An antenna circuitry 124 may be connected or connectable to radio circuitry 122 for signal reception or transmittance and/or amplification. The network node 100 may be adapted to carry out any of the methods for operating a network node disclosed herein; in particular, it may comprise corresponding circuitry, e.g. control circuitry.

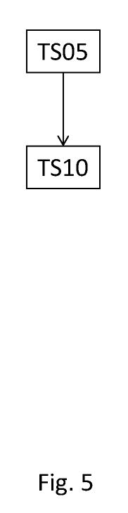

FIG. 5 shows a flowchart for a method for operating a user equipment, which may be any of the user equipments described herein. The method comprises an action TS10 of operating based on a measurement configuration, wherein operating comprises operating with one direction of transmission during measurement or positioning subframes configured by the configuration. Optionally, the method may comprise an action TS05 of receiving a configuration for carrier aggregation and/or a measurement configuration. Action TS10 may be performed after and/or based on action TS05, respectively the configuration/s received therein.

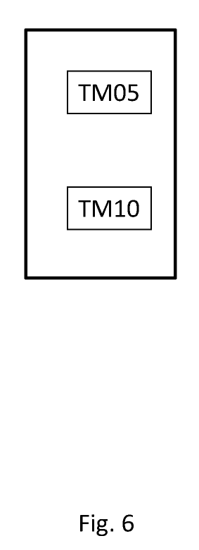

FIG. 6 shows a user equipment, which may be any of the user equipments described herein. The user equipment comprises an operating module TM10 for performing action TS10. Optionally, the user equipment may comprise a receiving module for performing action TS05. The operating module TM10 may be adapted for performing action TS10 after and/or based on action TS05, respectively the configuration/s received therein.

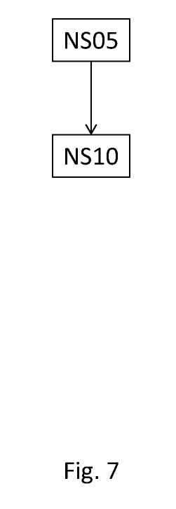

FIG. 7 shows a flowchart for a method for operating a network node, which may be any network node described herein. The method comprises an action NS10 of configuring a user equipment configured for carrier aggregation with a measurement configuration for operating with one direction of transmission during measurement or positioning subframes configured by the configuration. The method may comprise an optional action NS05 of configuring the user equipment for carrier aggregation. Action NS05 may be performed after action NS10 or simultaneously, e.g. with the same configuration (e.g., the same message).

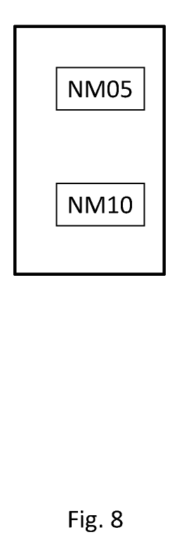

FIG. 8 shows a network node, which may be any of the network nodes described herein. The network node comprises a configuring module NM10 for performing action NS10. Optionally, the network node may comprise a carrier aggregation configuring module NM05 for performing action NS05. The configuring module NM10 may be adapted for performing action NS10 after and/or based on action NS05. Alternatively, it may be considered that the configuring module NM10 is adapted for performing actions NS05 and NS10 simultaneously, e.g. with the same configuration and/or configuration message (which may generally represent allocation data indicating the configuration).

In addition, there is suggested a network node for a wireless communication network, the network node being adapted for configuring a user equipment configured for carrier aggregation with a measurement configuration for operating with one direction of transmission during measurement or positioning subframes configured by the configuration.

There may be considered a network node adapted for performing any one of the methods for operating a network node described herein.

There may be considered a user equipment adapted for performing any one of the methods for operating a user equipment described herein.

There is also disclosed a program product comprising code executable by control circuitry, the code causing the control circuitry to carry out and/or control any one of the method for operating a user equipment or network node as described herein, in particular if executed on control circuitry, which may be control circuitry of a user equipment or a network node.

Moreover, there is disclosed a carrier (or storage) medium arrangement carrying and/or storing at least any one of the program products described herein and/or code executable by control circuitry, the code causing the control circuitry to perform and/or control at least any one of the methods described herein. A carrier medium arrangement may comprise one or more carrier media. Generally, a carrier medium may be accessible and/or readable and/or receivable by control circuitry. Storing data and/or a program product and/or code may be seen as part of carrying data and/or a program product and/or code. A carrier medium generally may comprise a guiding/transporting medium and/or a storage medium. A guiding/transporting medium may be adapted to carry and/or carry and/or store signals, in particular electromagnetic signals and/or electrical signals and/or magnetic signals and/or optical signals. A carrier medium, in particular a guiding/transporting medium, may be adapted to guide such signals to carry them. A carrier medium, in particular a guiding/transporting medium, may comprise the electromagnetic field, e.g. radio waves or microwaves, and/or optically transmissive material, e.g. glass fiber, and/or cable. A storage medium may comprise at least one of a memory, which may be volatile or non-volatile, a buffer, a cache, an optical disc, magnetic memory, flash memory, etc.

A user equipment or terminal being configured with a cell, e.g. a serving cell, and/or carrier, and/or being connected to a network node via a cell, may be in a state in which it may communicate (transmit and/or receive data, e.g. with the network node) using the cell or carrier, e.g. being registered with the network for communication and/or being synchronized to the cell and/or carrier; in particular, the cell may be activated for the user equipment or terminal and/or the latter may be in an RRC_connected or RRC_idle state regarding the cell or the node providing the cell. A serving cell may be associated with one or more serving carriers. A cell may be defined by the carriers it comprises and/or an area of coverage associated to it. Generally, a UE may be adapted for carrier aggregation and/or be configured for carrier aggregation, e.g. by a network node.

Adapting a configuration may comprise determining the configuration (e.g., determining parameters and/or conditions representing the configuration) and/or configuring a UE with the configuration, for example by transmitting corresponding allocation data. Determining a configuration may be performed according to a standard, and/or based on stored and/or pre-defined information (e.g., read from a memory, e.g. from a table stored in memory) and/or based on measurements, which may be performed by the determining nodes and/or reported upon e.g. by one or more UEs, and/or based on operational conditions, e.g. network load situation, transmission conditions, etc.

A primary cell may be a cell in or to which a UE either performs the initial connection establishment procedure or initiates the connection re-establishment procedure, or the cell indicated as the primary cell in a handover procedure.

A secondary cell may be cell, operating on a secondary frequency and/or carrier, which may be configured once an RRC connection is established and which may be used to provide additional radio resources. For carrier aggregation, the term “serving cell” may refer to the set of one or more cells comprising of the primary cell and all secondary cells of the carrier aggregation.

Generally, carrier aggregation (CA) may refer to the concept of a radio connection and/or communication link between a wireless and/or cellular communication network and/or network node and a terminal comprising a plurality of carriers for at least one direction of transmission (e.g. DL and/or UL), as well as to the aggregate of carriers. A corresponding communication link may be referred to as carrier aggregated communication link or CA communication link; carriers in a carrier aggregate may be referred to as component carriers (CC). In such a link, data may be transmitted over more than one of the carriers and/or all the carriers of the carrier aggregation (the aggregate of carriers). A carrier aggregation may comprise one (or more) dedicated control carriers and/or primary carriers (which may e.g. called primary component carrier or PCC), over which control information may be transmitted, wherein the control information may refer to the primary carrier and other carriers, which may be referred to as secondary carriers (or secondary component carrier, SCC).

Control information may comprise scheduling information and/or allocation data and/or HARQ signaling, in particular in regards to a DL connection. A communication link may comprise an UL connection and/or a DL connection. It may be considered that a communication link comprise different carriers and/or carrier aggregations for UL and/or DL; in particular, it may be considered that a communication link comprises one or more carriers and/or carrier aggregations for DL and a different number of carriers and/or carrier aggregations for UL, which may use different frequencies than the DL carriers.

Carriers in a carrier aggregation may comprise carrier/s in a licensed spectrum and/or carrier/s in an unlicensed spectrum. In particular, carrier/s of an unlicensed spectrum may be secondary carriers of a carrier aggregation. It may be considered that primary carriers are in a licensed spectrum. Generally, before accessing a carrier in an unlicensed spectrum for transmission, a listen-before-talk (LBT) procedure may be performed, e.g. by a correspondingly adapted terminal or network node. Carriers of a carrier aggregation may belong to different frequency bands, e.g. as defined in a given standard as LTE and/or in terms of frequency and/or spectral width, and/or whether they are licensed or not.

Different carriers may be associated to different frequency bands; it may be considered that different frequency bands have different carriers (one or more than one carrier per frequency band may generally be envisaged) associated to them. Licensed bands or spectra may have different frequency bands than unlicensed bands or spectra. A control carrier may be a primary carrier used for control information transmission, e.g. for the transmission of HARQ feedback and/or for CSI information and/or scheduling requests. Generally, a DL carrier aggregation may comprise more than 2, more particular more than 5, in particular between 6 and 32 carriers (including the boundary values).

Configuring a terminal or UE, e.g. by a network or network node, may comprise transmitting, by the network or network node, one or more parameters and/or commands and/or allocation or control data to the terminal or UE, and/or the terminal or UE changing its configuration and/or setup, e.g. based on received parameters and/or commands and/or allocation data from the network and/or the network node.

In the context of this description, wireless communication may be communication, in particular transmission and/or reception of data, via electromagnetic waves and/or an air interface, in particular radio waves, e.g. in a wireless communication network and/or utilizing a radio access technology (RAT). The communication may be between nodes of a wireless communication network and/or in a wireless communication network. It may be envisioned that a node in or for communication, and/or in, of or for a wireless communication network is adapted for, and/or for communication utilizing, one or more RATs, in particular LTE/E-UTRA. A communication may generally involve transmitting and/or receiving messages, in particular in the form of packet data. A message or packet may comprise control and/or configuration data and/or payload data and/or represent and/or comprise a batch of physical layer transmissions. Control and/or configuration data may refer to data pertaining to the process of communication and/or nodes of the communication. It may, e.g., include address data referring to a node of the communication and/or data pertaining to the transmission mode and/or spectral configuration and/or frequency and/or coding and/or timing and/or bandwidth as data pertaining to the process of communication or transmission, e.g. in a header. Each node involved in such communication may comprise radio circuitry and/or control circuitry and/or antenna circuitry, which may be arranged to utilize and/or implement one or more than one radio access technologies. Radio circuitry of a node may generally be adapted for the transmission and/or reception of radio waves, and in particular may comprise a corresponding transmitter and/or receiver and/or transceiver, which may be connected or connectable to antenna circuitry and/or control circuitry. Control circuitry of a node may comprise a controller and/or memory arranged to be accessible for the controller for read and/or write access. The controller may be arranged to control the communication and/or the radio circuitry and/or provide additional services. Circuitry of a node, in particular control circuitry, e.g. a controller, may be programmed to provide the functionality described herein. A corresponding program code may be stored in an associated memory and/or storage medium and/or be hardwired and/or provided as firmware and/or software and/or in hardware. A controller may generally comprise a processor and/or microprocessor and/or microcontroller and/or FPGA (Field-Programmable Gate Array) device and/or ASIC (Application Specific Integrated Circuit) device. More specifically, it may be considered that control circuitry comprises and/or may be connected or connectable to memory, which may be adapted to be accessible for reading and/or writing by the controller and/or control circuitry. Radio access technology may generally comprise, e.g., Bluetooth and/or Wifi and/or WIMAX and/or cdma2000 and/or GERAN and/or UTRAN and/or in particular E-Utran and/or LTE. A communication may in particular comprise a physical layer (PHY) transmission and/or reception, onto which logical channels and/or logical transmission and/or receptions may be imprinted or layered. A node of a wireless communication network may be implemented as a D2D device and/or user equipment and/or base station and/or relay node and/or any device generally adapted for device-to-device communication. A wireless communication network may comprise at least one of a device configured for device-to-device communication, a D2D device, and/or a user equipment and/or base station and/or relay node, in particular at least one user equipment, which may be arranged for device-to-device communication with a second D2D device or node of the wireless communication network, in particular with a second user equipment. A node of or for a wireless communication network may generally be a wireless device configured for wireless device-to-device communication, in particular using the frequency spectrum of a cellular and/or wireless communications network, and/or frequency and/or time resources of such a network. Device-to-device communication may optionally include broadcast and/or multicast communication to a plurality of devices or nodes. A cellular network may comprise a network node, in particular a radio network node, which may be connected or connectable to a core network, e.g. a core network with an evolved network core, e.g. according to LTE. The connection between the network node and the core network/network core may be at least partly based on a cable/landline connection. Operation and/or communication and/or exchange of signals involving part of the core network, in particular layers above a base station or eNB, and/or via a predefined cell structure provided by a base station or eNB, may be considered to be of cellular nature or be called cellular operation. Operation and/or communication and/or exchange of signals without involvement of layers above a base station and/or without utilizing a predefined cell structure provided by a base station or eNB, may be considered to be D2D communication or operation, in particular, if it utilises the radio resources, in particular carriers and/or frequencies, and/or equipment (e.g. circuitry like radio circuitry and/or antenna circuitry, in particular transmitter and/or receiver and/or transceiver) provided and/or used for cellular operation.

A storage medium may be adapted to store data and/or store instructions executable by control circuitry and/or a computing device, the instruction causing the control circuitry and/or computing device to carry out and/or control any one of the methods described herein when executed by the control circuitry and/or computing device. A storage medium may generally be computer-readable, e.g. an optical disc and/or magnetic memory and/or a volatile or non-volatile memory and/or flash memory and/or RAM and/or ROM and/or EPROM and/or EEPROM and/or buffer memory and/or cache memory and/or a database.

A network device or node and/or a user equipment may be or comprise a software/program arrangement arranged to be executable by a hardware device, e.g. control circuitry, and/or storable in a memory, which may provide dual connectivity functionality and/or corresponding control functionality and/or control functionality to carry out any one of the methods described herein and/or to implement any one or more than one functionalities of a user equipment and/or network node described herein.

Radio spectrum: Although at least some of the embodiments may be described for D2D transmissions in the UL spectrum (FDD) or UL resources (TDD), the embodiments are not limited to the usage of UL radio resources, neither to licensed or unlicensed spectrum, or any specific spectrum at all.

A cellular network or mobile or wireless communication network may comprise e.g. an LTE network (FDD or TDD), UTRA network, CDMA network, WiMAX, GSM network, any network employing any one or more radio access technologies (RATs) for cellular operation. The description herein is given for LTE, but it is not limited to the LTE RAT.

RAT (radio access technology) may generally include: e.g. LTE FDD, LTE TDD, GSM, CDMA, WCDMA, WiFi, WLAN, WiMAX, etc.

Transmitting and receiving simultaneously may refer to transmitting and receiving at the same time and/or within the same subframe.

A measurement gap may refer to a time gap or interval, in which no transmission and reception happens, in particular regarding a serving cell or a given carrier. Since there is no signal transmission and reception during the gap (at least in the serving cell or given carrier), a UE can switch to another or a target cell or carrier and/or perform a measurement on the target cell or carrier, e.g. for signal quality, utilizing the same receiver.

The term “intra-frequency” may refer to issued related to the same frequency/bandwith and/or carrier, e.g. between neighboring cells (which may be provided by different BSs) having the same frequencies available. The term “inter-frequency” may refer to issues related to different frequencies/bandwidths and/or carriers, e.g. between different carriers in a multi-carrier arrangement.

A receiving operation may comprise a measurement operation, e.g. a signal quality measurement, which may be performed in a measurement gap, in which a receiver switching to a carrier/frequency to be measured may be performed.

Transmitting a subframe may indicate that a transmission occurs in the subframe. Transmitting in the same direction may refer to a viewpoint of a party of the connection in which the transmissions occur. In particular, transmitting in the same direction may indicate that there is a receiver receiving all of the transmissions transmitted in the same direction (e.g. two transmissions, which may originate from one or more transmitters, e.g. network nodes). Accordingly, the involvement of the receiver may require the receiver only to receive, but not to simultaneously transmit.

A network node may be a radio network node (which may be adapted for wireless or radio communication, e.g. with a UE) or another network node. A network node generally may be a controlling node. Some examples of a radio network node or controlling node are a radio base station, in particular an eNodeB, a relay node, an access point, a cluster head, RNC, etc. The radio network node may be comprised in a mobile communication network and may support and/or be adapted for cellular operation or communication and/or D2D operation or communication. A network node, in particular a radio network node, may comprise radio circuitry and/or control circuitry, in particular for wireless communication. Some examples of a network node, which is not a radio network node, may comprise: a core network node, MME, a node controlling at least in part mobility of a wireless device, SON node, O&M node, positioning node, a server, an application server, an external node, or a node comprised in another network. Any network node may comprise control circuitry and/or a memory. A network node may be considered to be serving a node or UE, if it provides a cell of a cellular network to the served node or UE and/or is connected or connectable to the UE via and/or for transmission and/or reception and/or UL and/or DL data exchange or transmission and/or if the network node is adapted to provide the UE with allocation and/or configuration data and/or a measurement performance characteristic and/or to configure the D2D device or UE.

Multiple carrier frequencies or functionality may refer to any of: different carrier frequencies within the same frequency band or within different frequency bands, same PLMN or different PLMNs, same RAT or different RATs. D2D operation may or may not occur on dedicated carrier frequencies. DL and UL carrier frequencies in FDD are also examples of different carrier frequencies.

A frequency band herein may be FDD, TDD, HD-FDD, or unidirectional (e.g., DL-only band such as Band 29, in some examples). Multiple carrier functionality may include carrier aggregation functionality, in which multiple carriers or cells are used for transmission and/or reception between two participants of communication. The carriers may be continuous in the spectrum or discontinuous.

Each or any one of the network nodes or user equipments shown in the figures may be adapted to perform the methods to be carried out by a user equipment described herein. Alternatively or additionally, each or any of the user equipments shown in the figures may comprise any one or any combination of the features of a user equipment described herein. Each or any one of the network nodes, e.g. anchor node or booster node, or controlling nodes or eNBs or base stations shown in the figures may be adapted to perform the methods to be carried out by network node or base station described herein. Alternatively or additionally, the each or any one of the controlling or network nodes or eNBs or base stations shown in the figures may comprise any one or any one combination of the features of a network node or eNB or base station described herein.

A UE operating, in particular on a carrier and/or cell, may comprise transmitting and/or receiving and/or measuring on that carrier and/or cell. Receiving may generally refer to receiving data and/or reference signals, and/or comprise decoding and/or demodulating the signal, e.g. for extraction of information content. Measuring in this context may refer to measuring reference and/or pilot signaling on that carrier or cell, e.g. regarding received signal strength and/or SIR/SINR/SNR, e.g. based on a known (e.g. configured and/or pre-defined) signal pattern and/or transmission format and/or transmission signal strength of the measured signal, which generally may be performed without decoding the received reference signal.

Some useful abbreviations include:

| Abbreviation | Explanation |
|---|---|
| CCA | Clear Channel Assessment |
| DCI | Downlink Control Information |
| DL | Downlink |
| DMRS | Demodulation Reference Signals |
| eNB | evolved NodeB, base station |
| TTI | Transmission-Time Interval |
| UE | User Equipment |
| UL | Uplink |
| LA | Licensed Assisted |
| LA | Licensed Assisted Access |
| DRS | Discovery Reference Signal |
| SCell | Secondary Cell |
| SRS | Sounding Reference Signal |
| LBT | Listen-before-talk |
| PCFICH | Physical Control Format Indicator Channel |
| PDCCH | Physical Downlink Control Channel |
| PUSCH | Physical Uplink Shared Channel |
| PUCCH | Physical Uplink Control Channel |
| RRM | Radio Resource Management |
| CIS | Transmission Confirmation Signal |
| 3GPP | 3^{rd} Generation Partnership Project |
| Ack/Nack | Acknowledgment/Non-Acknowledgement, also A/N |
| AP | Access point |
| B1, B2, . . . Bn | Bandwidth of signals, in particular carrier bandwidth Bn assigned to |
| | corresponding carrier or frequency f1, f2, . . . , fn |
| BER/BLER | Bit Error Rate, BLock Error Rate; |
| CA | Carrier Aggregation |
| CC | component carrier (a carrier in a carrier aggregate) |
| CoMP | Coordinated Multiple Point Transmission and Reception |
| CQI | Channel Quality Information |
| CRS | Cell-specific Reference Signal |
| CSI | Channel State Information |
| CSI-RS | CSI reference signal |
| D2D | Device-to-device |
| DL | Downlink |
| EPDCCH | Enhanced Physical DL Control CHannel |
| DL | Downlink; generally referring to transmission of data to a node/into a |
| | direction further away from network core (physically and/or logically); in |
| | particular from a base station or eNodeB to a D2D enabled node or UE; often uses |
| | specified spectrum/bandwidth different from UL (e.g. LTE) |
| eNB | evolved NodeB; a form of base station, also called eNodeB |
| E-UTRA/N | Evolved UMTS Terrestrial Radio Access/Network, an example of a |
| | RAT |
| f1, f2, f3, . . . , fn | carriers/carrier frequencies; different numbers may indicate that the |
| | referenced carriers/frequencies are different |
| f1_UL, . . . , fn_UL | Carrier for Uplink/in Uplink frequency or band |
| f1_DL, . . . , fn_DL | Carrier for Downlink/in Downlink frequency or band |
| FDD | Frequency Division Duplexing |
| ID | Identity |
| L1 | Layer 1 |
| L2 | Layer 2 |
| LTE | Long Term Evolution, a telecommunications standard |
| MAC | Medium Access Control |
| MBSFN | Multiple Broadcast Single Frequency Network |
| MDT | Minimisation of Drive Test |
| MME | Mobility Management Entity; a control entity of a wireless communication |
| | network (LTE) providing control functionality e.g. for radio network nodes |
| | like eNBs |
| NW | Network |
| OFDM | Orthogonal Frequency Division Multiplexing |
| O&M | Operational and Maintenance |
| OSS | Operational Support Systems |
| PC | Power Control |
| PCell | Primary Cell (e.g. in CA, in particular a primary cell of a Master Cell |
| | Group) |
| PDCCH | Physical DL Control CHannel |
| PH | Power Headroom |
| PHR | Power Headroom Report |
| Pscell | primary cell of a secondary cell group |
| PSS | Primary Synchronization Signal |
| PUSCH | Physical Uplink Shared CHannel |
| R1, R2, . . . , Rn | Resources, in particular time-frequency resources, in particular |
| | assigned to corresponding carrier f1, f2, . . . , fn |
| RA | Random Access |
| RACH | Random Access Channel |
| RAN | Radio Access Network |
| RAT | Radio Access Technology |
| RE | Resource Element |
| RB | Resource Block |
| RRH | Remote radio head |
| RRM | Radio Resource Management |
| RRU | Remote radio unit |
| RSRQ | Reference signal received quality |
| RSRP | Reference signal received power |
| RSSI | Received signal strength indicator |
| RX | reception/receiver, reception-related |
| SA | Scheduling Assignment |
| SCell | Secondary Cell (e.g. in CA) |
| SINR/SNR | Signal-to-Noise-and-Interference Ratio; Signal-to-Noise Ratio |
| SFN | Single Frequency Network |
| SON | Self Organizing Network |
| SSS | Secondary Synchronization Signal |
| TPC | Transmit Power Control |
| TX | transmission/transmitter, transmission-related |
| TDD | Time Division Duplexing |
| UE | User Equipment |
| UL | Uplink; generally referring to transmission of data to a node/into a |
| | direction closer to a network core (physically and/or logically); in |
| | particular from a D2D enabled node or UE to a base station or eNodeB; in the |
| | context of D2D, it may refer to the spectrum/bandwidth utilized for transmitting in |
| | D2D, which may be the same used for UL communication to a eNB in cellular |
| | communication; in some D2D variants, transmission by all devices involved in D2D |
| | communication may in some variants generally be in UL |
| | spectrum/bandwidth/carrier/frequency |
| DC | Dual Connectivity |
| MCG | Main Cell Group |
| SCG | Secondary Cell Group |
| PCell | Primary Cell |
| PSCell | Primary SCell |
| SCell | Secondary Cell |
| RACH | Random Access CHannel |
| MeNB | Master eNodeB |
| SeNB | Secondary eNodeB |
| pSCell | Primary SCell |
| PCC | Primary component carrier |
| PCI | Physical cell identity |
| PSS | Primary synchronization signal |
| RAT | Radio Access Technology |
| RRC | Radio resource control |
| RSCP | Received signal code power |
| RSRP | Reference Signal Received Power |
| RSRQ | Reference Signal Received Quality |
| RSSI | Received signal strength indication |
| SCC | Secondary component carrier |
| SIB | System information block |
| SON | Self-organizing networks |
| SSS | Secondary synchronization signal |
| TDD | Time division duplex |
| UARFCN | UMTS Absolute Radio Frequency Channel Number |
| HO | Handover |
| UE | User equipment |
| RNC | Radio Network Controller |
| BSC | Base station Controller |
| PCell | Primary Cell |
| SCell | Secondary Cell |
| BS | Base Station |
| D2D | Device-to-Device |
| HD | Half Duplex |
| UE | User Equipment |
| BCH | Broadcast channel |
| BS | Base Station |
| CA | Carrier Aggregation |
| CGI | Cell global identifier |
| CPICH | Common Pilot Channel |
| EARFCN | Evolved absolute radio frequency channel number |
| ECGI | Evolved CGI |
| E-CID | Enhanced cell ID |
| E-SMLC | Evolved SMLC |
| GSM | Global System for Mobile Communications |
| HARQ | Hybrid Automatic Repeat Request |
| L1 | Layer 1 |
| L2 | Layer 2 |
| MIB | Master Information Block |
| MME | Mobility management entity |
| OFDM | Orthogonal Frequency Division Modulation |
| OFDMA | Orthogonal Frequency Division Multiple Access |
| O&M | Operational and Maintenance |
| OTDOA | Observed time difference of arrival |
| PBCH | Physical Broadcast Channel |
| PCI | Physical cell identifier |
| RAT | Radio Access Technology |
| RRC | Radio Resource Control |
| RSRQ | Reference signal received quality |
| RSRP | Reference signal received power |
| RSTD | Reference signal time difference |
| SIB | System information block |
| SI | System information |
| UE | User Equipment |

X2 - an interface for BS-to-BS communication in LTE

These and other abbreviations may be used according to LTE standard definitions.

In this description, for purposes of explanation and not limitation, specific details are set forth (such as particular network functions, processes and signalling steps) in order to provide a thorough understanding of the technique presented herein. It will be apparent to one skilled in the art that the present concepts and aspects may be practiced in other embodiments and variants that depart from these specific details.

For example, the concepts and variants are partially described in the context of Long Term Evolution (LTE) or LTE-Advanced (LTE-A) mobile or wireless communications technologies; however, this does not rule out the use of the present concepts and aspects in connection with additional or alternative mobile communication technologies such as the Global System for Mobile Communications (GSM). While the following embodiments will partially be described with respect to certain Technical Specifications (TSs) of the Third Generation Partnership Project ( 3GPP), it will be appreciated that the present concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the embodiments described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. Because the aspects presented herein can be varied in many ways, it will be recognized that any scope of protection should be defined by the scope of the claims that follow without being limited by the description.

1. A method for operating a user equipment for a wireless communication network, the user equipment being configured for carrier aggregation, the method comprising operating based on a measurement configuration, the operating including one of operating with one direction of transmission during measurement and positioning subframes configured by the configuration.

2. A user equipment for a wireless communication network, the user equipment being configured for carrier aggregation, the user equipment further being configured to operate based on a measurement configuration, the operating including one of operating with one direction of transmission during measurement and positioning subframes configured by the configuration.

3. A method for operating a network node for a wireless communication network, the method comprising configuring a user equipment configured for carrier aggregation with a measurement configuration for one of operating with one direction of transmission during measurement and positioning subframes configured by the configuration.

4. A network node for a wireless communication network, the network node being configured to configure a user equipment configured for carrier aggregation with a measurement configuration for one of operating with one direction of transmission during measurement and positioning subframes configured by the configuration.

5-6. (canceled)
